(19) United States
(12) Patent Application Publication
(10) Pub. No.: US 2026/0363180 A1
(43) Pub. Date: Nov. 19, 2026

(54) System and Method for Cultivating Plants by Replicating Native-Habitat Environmental Conditions in Networked Grow Units

(71) Applicant: David Andrew Bulloch Hyde, Nashville, TN (US)

(72) Inventor: David Andrew Bulloch Hyde, Nashville, TN (US)

(21) Appl. No.: 19/731,005

(22) Filed: Jul. 4, 2026

(51) Int. Cl. A01G 9/26; A01G 7/04; A01G 9/14

(52) U.S. Cl. CPC A01G 9/26; A01G 7/045; A01G 9/14

(57) ABSTRACT

A cultivation system derives a plant species' growing conditions from its wild native habitat and replicates them in remote grow units. Ruggedized, solar-powered, satellite-connected field stations in the species' native range stream a fine-grained, multi-year in-situ environmental time-series to a server, which derives a target habitat profile of diel and seasonal setpoints. A grow unit having a growth chamber, sensors, a camera, and actuators is controlled to track the profile, replicating the endemic habitat. Where multiple units grow the species, the server refines conditions by assigning different condition sets to different units within safe bounds derived from the observed habitat range, updating a growth-response model from computer vision phenotype metrics and returning refined control profiles. Bayesian optimization warm-started from the habitat data enables sample-efficient tuning for rare species with few specimens, transitioning to supervised or reinforcement learning as data accumulates.

### CROSS-REFERENCE TO RELATED APPLICATIONS

None. This application is filed as an original U.S. non-provisional utility application and does not claim priority to any earlier-filed application.

### FIELD OF THE INVENTION

The present invention relates to controlled-environment horticulture, and more particularly to networked grow units and a server-based system that derives target environmental conditions for a plant species from in-situ measurements of the species' wild native habitat, and that automatically controls one or more grow units to replicate those conditions, optionally refining them through coordinated, safety-bounded experimentation across a plurality of units.

### BACKGROUND OF THE INVENTION

Many prized ornamental and horticulturally significant plants—for example exotic cacti such as Astrophytum asterias (star cactus), certain orchids, carnivorous plants, alpines, and rare succulents—have narrow and poorly documented environmental requirements. Such species may demand particular combinations of light intensity and spectrum, day-night (“diel”) and seasonal temperature cycles, humidity, substrate composition, and watering regimes in order to germinate, survive, and thrive. Where a species is rare, endangered, slow-growing, or represented by only a small number of available seeds or specimens, conventional trial-and-error cultivation is costly: each failed attempt may consume an irreplaceable specimen, and the small number of specimens makes it difficult to accumulate enough data to characterize what the species needs.

Consumer “smart garden” and controlled-environment appliances are known. Such products typically include environmental sensors, a controllable light, and a companion software application, and may provide a user with reminders or with per-unit adjustments based on preset recipes for common herbs and vegetables. Some systems add a camera and per-unit machine learning to detect plant health. Networked and cloud-connected grow systems are also known, including systems that aggregate data from a plurality of grow devices and apply machine learning to compute growing parameters that are distributed back to the devices, and research systems that record the weather at a location and replay it inside a controlled chamber.

However, existing approaches share a common limitation: the environmental targets they use are derived from the grow devices themselves (from prior cultivation attempts, from operator-defined recipes, or from generic agronomic models) rather than from the environment in which the species actually evolved. For a rare species with few specimens, device-derived learning converges slowly precisely because specimens are scarce, and operator-defined recipes require pre-existing horticultural knowledge that may not exist. Moreover, general-purpose experimentation systems that vary conditions across grow units bound their exploration using operator-defined limits, which for an uncharacterized species are themselves guesses.

A plant species is, through natural selection, adapted to the environmental conditions of its native habitat. There is accordingly a need for a cultivation system that determines target conditions from direct, long-baseline measurement of a species' wild native habitat, that automatically replicates those conditions in a grow unit, and that—where multiple units are available—refines conditions through coordinated experimentation whose safe exploration bounds are themselves derived from the naturally observed range of the habitat, so that even rare species with few specimens can be cultivated reliably and sample-efficiently.

### SUMMARY OF THE INVENTION

The following summary presents selected aspects of the invention and is not intended to limit the claims.

In one aspect, a cultivation system comprises one or more field stations deployed in the wild native range of a plant species and a server. Each field station is ruggedized for unattended long-term outdoor operation, is powered by a solar source, and communicates over a satellite or long-range wireless link. The field station measures environmental parameters at the native habitat over an extended period at fine temporal granularity and transmits the resulting in-situ environmental time-series to the server. The server derives, from the time-series, a target habitat profile for the species, the profile specifying target values of one or more environmental parameters as a function of time of day and time of year (a diel and seasonal schedule). A grow unit remote from the native range—for example a tabletop or home grow unit—includes a growth chamber, one or more environmental sensors, and one or more environmental actuators. A controller operates the actuators so as to cause measured conditions inside the growth chamber to track the target habitat profile, thereby replicating the species' endemic habitat, and adjusts the actuators based on feedback from the environmental sensors.

In another aspect, a method comprises: receiving, from at least one field station in a plant species' wild native range, an in-situ environmental time-series; deriving from the time-series a target habitat profile including diel and seasonal setpoint schedules; and controlling one or more environmental actuators of a grow unit remote from the native range to cause conditions in a growth chamber to track the target habitat profile, including adjusting at least one of a light output, a temperature, a humidity, and an irrigation of the growth chamber responsive to both the target habitat profile and to feedback from environmental sensors of the grow unit.

In another aspect, the system further comprises a plurality of grow units each growing a specimen of the same species, and the server refines the target conditions by conducting a coordinated, safety-bounded experiment across the plurality of grow units. The server assigns different candidate environmental condition sets to different grow units, receives, for each grow unit, one or more phenotype metrics derived by computer vision analysis of images of the specimen (for example plant height, width, projected area, or color/health indices), and updates a model of the species' growth response. A distinguishing feature is that the safe exploration bounds constraining the assigned condition sets—the permissible range within which each environmental parameter may be varied—are derived from the range of that parameter observed in the in-situ habitat time-series, so that experimentation never places a specimen outside conditions the species naturally encounters. The server transmits refined environmental profiles to the grow units to close the loop.

In further aspects: the server applies Bayesian optimization, using a surrogate model warm-started with a prior derived from the native-habitat time-series, to select candidate condition sets sample-efficiently for a species of which few specimens are available, and transitions from Bayesian optimization to a supervised or reinforcement-learning control policy once accumulated data for the species exceeds a threshold; the grow unit includes a grow bed segmented into an array of independently conditioned cells for germinating seeds, per-cell conditions being varied and per-cell germination outcomes scored by computer vision to compute a germination-yield metric; and the server maintains per-species models and transmits control profiles rather than underlying aggregated data to protect the aggregated dataset.

These and other aspects are described in detail below with reference to the drawings.

### BRIEF DESCRIPTION OF THE DRAWINGS

FIG. 1 is a schematic diagram of a cultivation system according to an embodiment, showing a plurality of networked grow units, a server, and one or more native-habitat field stations interconnected by a network.

FIG. 2 is a block diagram of a grow unit according to an embodiment, showing the growth chamber, environmental sensors, camera, environmental actuators, controller, and communication interface.

FIG. 3 is a block diagram of the server according to an embodiment, showing data ingestion, per-species data and model stores, the habitat-profile store, the optimization/experiment engine, and the profile-generation and security modules.

FIG. 4 is a flow diagram of a coordinated, safety-bounded experiment conducted across a plurality of grow units, including derivation of exploration bounds from the native-habitat range.

FIG. 5 is a flowchart of staged control transitioning from Bayesian optimization to a supervised or reinforcement-learning control policy as accumulated data increases.

FIG. 6 is a data-flow diagram of a computer vision phenotyping pipeline that derives phenotype metrics from images of a specimen.

FIG. 7 is a schematic diagram of a native-habitat field station and the derivation of a target habitat profile and replication schedule from the in-situ time-series.

FIG. 8 is a schematic plan and section view of a grow bed segmented into an m×n array of independently conditioned cells with per-cell germination scoring.

FIG. 9 is a flowchart of a representative method of operation (sense→aggregate→experiment→learn→actuate).

FIG. 10 is a flowchart of an optional selective-breeding embodiment (grow→phenotype→select→breed→progeny→next cycle).

### DETAILED DESCRIPTION OF THE INVENTION

The following description is of exemplary embodiments and is not intended to limit the scope of the claims. Numerous specific details are provided to convey a thorough understanding; however, the invention may be practiced without one or more of these details, and features of separately described embodiments may be combined. Section headings are for convenience only. As used herein, “comprising” is open-ended; “a” and “an” mean “one or more”; and recitations of ranges include their endpoints unless otherwise stated. Where a component is described as performing a function, that description encompasses a processor executing instructions stored on a non-transitory computer-readable medium to perform the function.

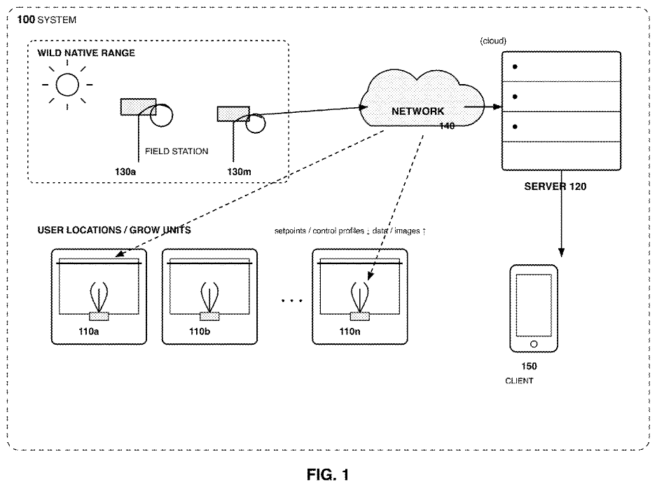

### 1. System Overview (FIG. 1)

FIG. 1 depicts a cultivation system 100. The system 100 comprises a plurality of grow units 110 (individual units 110a, 110b, . . . 110n), a server 120, and one or more native-habitat field stations 130 (individual stations 130a . . . 130m), interconnected by one or more networks 140. The network 140 may comprise the Internet, cellular data networks, local-area networks, and, for the field stations 130, a satellite data service or other long-range wireless link. One or more user client devices 150 (for example a smartphone application or web client) may communicate with the server 120 and/or with a grow unit 110.

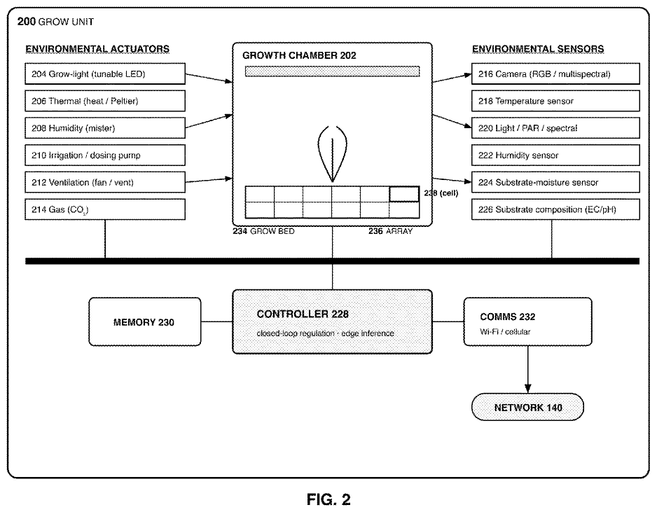

The grow units 110 are, in a preferred embodiment, tabletop or home-scale enclosed grow units suitable for placement indoors. Each grow unit 110 is capable of growing at least one specimen of a plant species and of sensing and controlling environmental conditions within it, as described with reference to FIG. 2. The grow units 110 may be geographically distributed and independently owned or operated by different users. A subset or all of the grow units 110 may grow specimens of the same plant species; the server 120 associates each grow unit 110 with the species of the specimen it is growing.

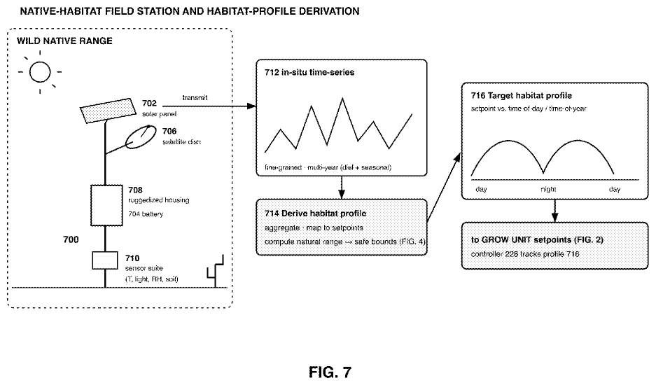

The field stations 130 are deployed in the wild native range (the endemic habitat) of a plant species—for example, a field station 130 for Astrophytum asterias may be deployed within the species' native range in the Lower Rio Grande Valley of Texas and adjacent Tamaulipas, Mexico. Each field station 130 measures environmental parameters at the habitat and streams the resulting in-situ environmental time-series to the server 120, as described with reference to FIG. 7.

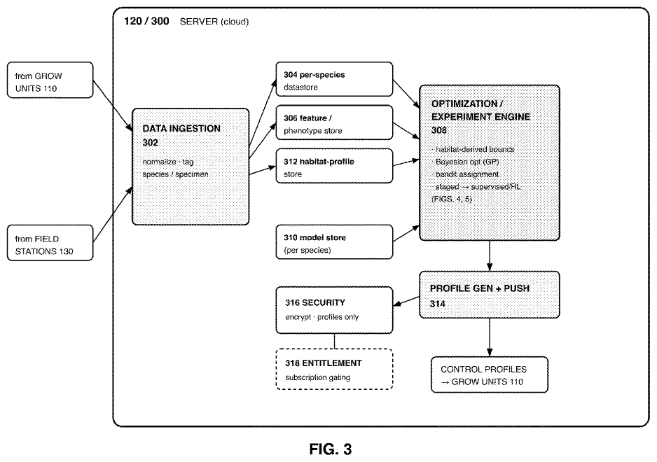

The server 120 (which may be one or more physical or virtual machines, including a cloud computing service) receives (i) growth and phenotype data from the grow units 110 and (ii) in-situ environmental time-series from the field stations 130; derives, per species, a target habitat profile and, optionally, refined environmental profiles; and transmits environmental control profiles to the grow units 110, causing them to adjust their environmental actuators. The server 120 is described with reference to FIG. 3.

### 2. Grow Unit (FIG. 2)

FIG. 2 is a block diagram of a representative grow unit 110/200. The grow unit 200 comprises an enclosure defining a growth chamber 202 in which one or more plant specimens are grown. The growth chamber 202 may be substantially closed so as to permit control of its internal atmosphere and to isolate it from ambient room conditions.

The grow unit 200 includes one or more environmental actuators operable to alter conditions within the growth chamber 202, which may include any one or more of: a grow-light assembly 204, preferably comprising light-emitting diodes whose intensity and, optionally, spectral composition are controllable (for example independently controllable channels for different wavelength bands, permitting reproduction of a target spectral power distribution and photoperiod); a thermal actuator 206 operable to heat and/or cool the growth chamber 202 (for example a resistive heater, a thermoelectric/Peltier device, or a vapor-compression element); a humidity actuator 208 (for example an ultrasonic mister, an evaporative humidifier, or a desiccant/dehumidifier); an irrigation subsystem 210 operable to deliver a controlled quantity of water and, optionally, dissolved nutrients to the substrate (for example one or more metering pumps, valves, or drip emitters, optionally with independently addressable outputs); a ventilation actuator 212 (for example one or more fans or controllable vents for air exchange); and a gas actuator 214 (for example a source or scrubber controlling carbon-dioxide concentration).

The grow unit 200 includes one or more environmental sensors, which may include any one or more of: one or more cameras 216 arranged to image the specimen (for example an RGB camera, and/or a multispectral, hyperspectral, infrared, or fluorescence imaging device); a temperature sensor 218; a light sensor 220 (for example a photosynthetically-active-radiation sensor and/or a spectral sensor); a humidity sensor 222; a substrate-moisture sensor 224; and a substrate-composition sensor 226 (for example a sensor of electrical conductivity, pH, or specific ion concentration of the substrate or of the substrate solution). Additional sensors (for example air-flow, weight/load cells for gravimetric water measurement, or gas-concentration sensors) may be included. In some embodiments, the irrigation subsystem 210 further comprises a dosing subsystem operable to deliver one or more of a nutrient, an acid, and a base so as to adjust a composition of a substrate solution—for example an electrical conductivity or a pH sensed by the substrate-composition sensor 226—toward a target value, whereby the controller 228 causes a sensed substrate composition to track a target value of the target habitat profile.

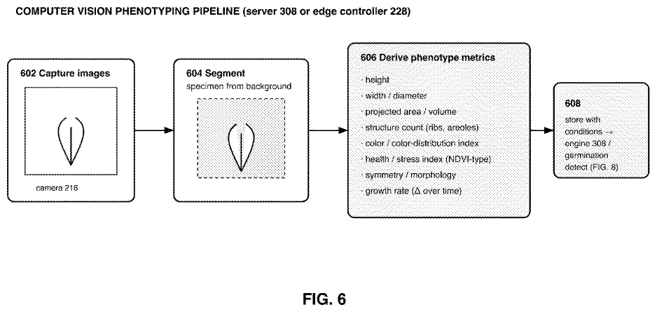

A controller 228 (for example a microprocessor or microcontroller) is coupled to the actuators and sensors and executes instructions stored in a memory 230 to operate the actuators responsive to sensor feedback and to control profiles received from the server 120 via a communication interface 232 (for example Wi-Fi, Ethernet, cellular, or other wireless or wired connection). The controller 228 may perform closed-loop regulation locally (for example proportional-integral-derivative or model-predictive regulation) so as to maintain measured conditions at setpoints specified by a control profile, and may buffer and transmit sensor data, images, and derived metrics to the server 120. In some embodiments the controller 228 performs edge inference—for example executing a computer vision model (FIG. 6) locally to derive phenotype metrics from images before transmission—to reduce bandwidth and to avoid transmitting raw imagery.

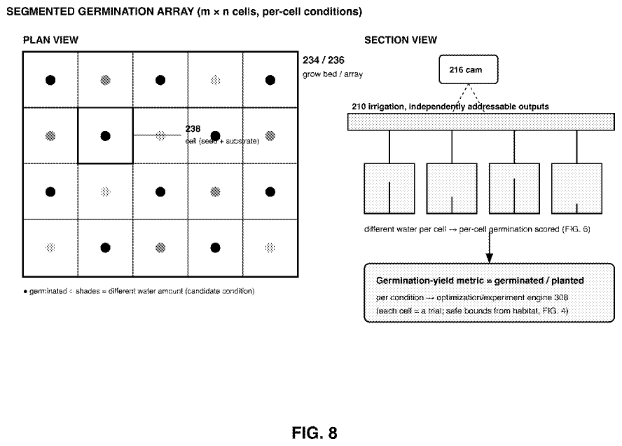

The grow unit 200 includes a grow bed 234 receiving substrate for the specimen(s). In some embodiments the grow bed 234 is segmented into an array 236 of independently conditioned cells 238, as described with reference to FIG. 8.

### 3. Server (FIG. 3)

FIG. 3 is a block diagram of the server 120/300. A data-ingestion module 302 receives and normalizes data from the grow units 110 (sensor readings, images or image-derived phenotype metrics, actuator states, and identifiers of the species and specimen) and from the field stations 130 (in-situ environmental time-series). Received data is stored in a per-species datastore 304 that partitions data by plant species, and phenotype metrics are stored in a feature store 306.

A habitat-profile store 312 stores, per species, a target habitat profile derived from the in-situ time-series of the field stations 130 (FIG. 7). A model store 310 stores, per species, one or more models of the species' growth response used by an optimization/experiment engine 308.

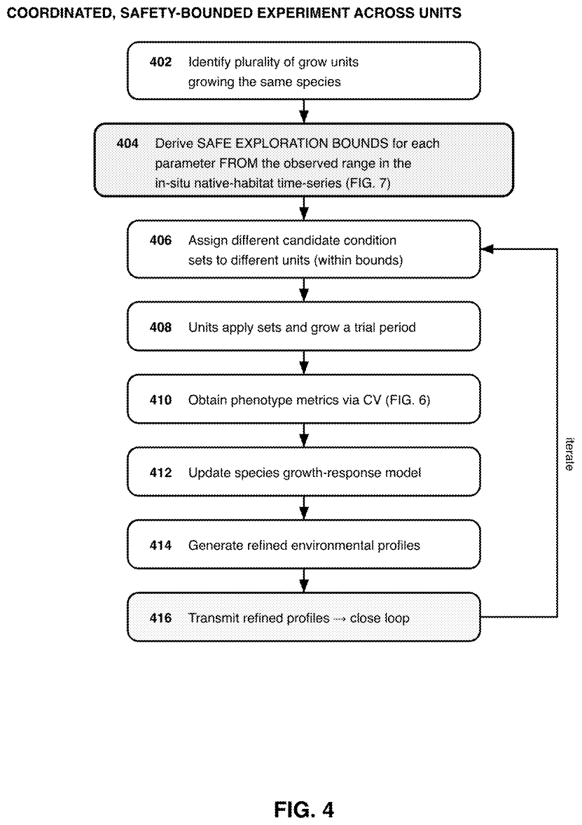

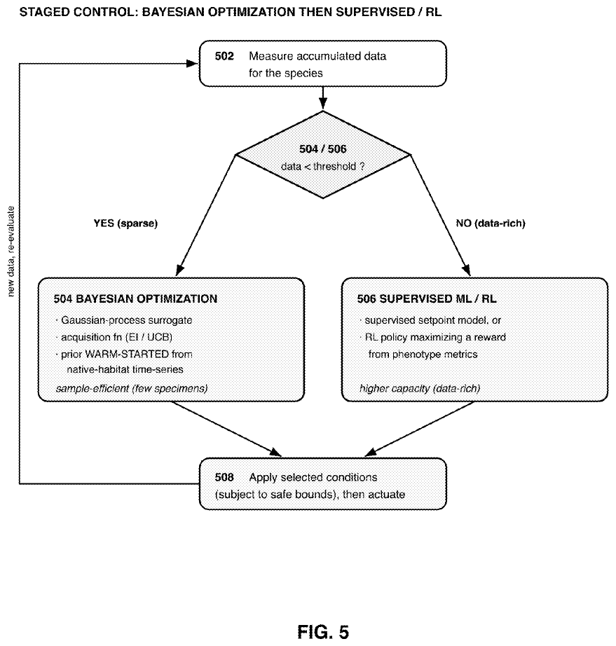

The optimization/experiment engine 308 (i) computes, per species, target and refined environmental profiles, (ii) where a plurality of grow units grow the same species, coordinates a safety-bounded experiment across those units (FIG. 4), and (iii) selects candidate condition sets and updates the growth-response model, including by Bayesian optimization and/or bandit assignment and by the staged control of FIG. 5. A profile-generation and push module 314 converts the engine's outputs into control profiles and transmits them to the grow units 110 via the network 140.

A security module 316 protects the aggregated data. In a preferred embodiment, the server 120 transmits to each grow unit 110 only control profiles (setpoints and schedules) and does not transmit the underlying aggregated cross-user dataset or the trained models; communications are encrypted; and the profiles may be cryptographically signed and/or bound to an entitlement so that only authorized grow units apply them. An entitlement/subscription module 318 may condition delivery of profiles or of specified capabilities on an account status; because the delivered artifact is a machine-applied control profile rather than the data, the aggregated dataset and models are not exposed to the user or to a competitor even while the benefit of the data is conferred.

### 4. Native-Habitat Field Station and Habitat-Profile Derivation (FIG. 7)

FIG. 7 depicts a field station 130/700 and the derivation of a target habitat profile. The field station 700 comprises a ruggedized housing 708 configured for unattended long-term outdoor deployment in a plant species' wild native range and to withstand environmental conditions of the habitat (for example temperature extremes, precipitation, dust, humidity, and ultraviolet exposure) over an extended period, in some embodiments for years without on-site maintenance. A solar panel 702 and a rechargeable battery 704 power the station so as to permit off-grid operation. A satellite transceiver 706 (or other long-range wireless transceiver) transmits data to the server 120, permitting deployment in remote locations lacking terrestrial connectivity.

The field station 700 includes a sensor suite 710 measuring environmental parameters at the habitat—for example air and/or substrate temperature, insolation/illumination (intensity and, optionally, spectrum), humidity or precipitation, substrate moisture, and substrate composition—at a fine temporal granularity (for example once per minute or per hour) over an extended baseline (for example spanning one or more annual cycles). The resulting in-situ environmental time-series 712 is transmitted to the server 120.

The server 120 derives, from the time-series 712 of one or more field stations 130 associated with the species, a target habitat profile 716 by a habitat-profile derivation process 714. The profile 716 specifies target values (and, in some embodiments, tolerances) of one or more environmental parameters as a function of time of day and time of year, thereby capturing the habitat's diel (day-night) and seasonal cycles. The derivation 714 may include aggregating multiple annual cycles, filtering and gap-filling, computing representative diel/seasonal curves (for example by day-of-year and time-of-day binning and statistical summarization), mapping habitat-measured quantities to grow-unit-controllable setpoints (for example converting measured insolation and spectrum to grow-light 204 intensity and channel settings, accounting for differences between field and chamber optics), and time-shifting the schedule to the grow unit's local time zone or, optionally, phase-shifting or compressing seasons. In some embodiments the derivation 714 also computes, for each environmental parameter, an observed natural range (for example minimum and maximum, or selected percentiles) that is later used as the safe exploration bound of FIG. 4.

The grow unit 110 is then controlled to track the target habitat profile 716: the profile's time-varying setpoints are provided to the controller 228, which operates the actuators 204-214 so that the measured conditions in the growth chamber 202 follow the setpoints, thereby replicating the species' endemic habitat in the grow unit and reproducing the diel and seasonal environmental cycles to which the species is adapted.

### 5. Coordinated, Safety-Bounded Experiment Across Units (FIG. 4)

FIG. 4 illustrates a coordinated experiment conducted by the server 120 across a plurality of grow units 110 that are growing specimens of the same species. At 402, the server identifies the plurality of grow units associated with the species. At 404, the server determines, for each of one or more environmental parameters, a safe exploration bound—a permissible range within which the parameter may be varied during experimentation. In a preferred embodiment, the safe exploration bound for a parameter is derived from the observed natural range of that parameter in the in-situ habitat time-series 712 (for example bounded by the minimum and maximum, or by selected percentiles, observed in the native habitat), optionally further constrained by absolute safety limits (for example a nonzero minimum illumination and an above-freezing minimum temperature) and by hardware limits of the grow units. Deriving the exploration bound from the naturally observed habitat range ensures that candidate conditions assigned during experimentation remain within conditions the species actually encounters in the wild.

At 406, the server assigns different candidate environmental condition sets to different grow units of the plurality (for example by an A/B or multi-arm assignment, or by a multi-armed-bandit or Thompson-sampling policy, or by Bayesian optimization as in FIG. 5), each assigned condition set lying within the safe exploration bounds. At 408, each grow unit applies its assigned condition set to grow its specimen over a trial period. At 410, for each grow unit, one or more phenotype metrics of the specimen are obtained by computer vision analysis of images captured by the camera 216 (FIG. 6). At 412, the server updates the species growth-response model using the assigned condition sets and the resulting phenotype metrics. At 414, the server generates refined environmental profiles based on the updated model and, at 416, transmits the refined profiles to grow units, closing the loop; the process may iterate. In this manner the plurality of independently operated units functions as a distributed experiment that accumulates, for a species, information that no single unit could obtain, which is particularly advantageous where the species is represented by few specimens.

### 6. Optimization and Staged Control (FIG. 5)

FIG. 5 is a flowchart of staged control performed by the optimization/experiment engine 308 for a species. At 502, the engine determines a measure of the quantity of data accumulated for the species (for example the number of completed trials or specimens). At 504, when the accumulated data is below a threshold—a sparse-data regime characteristic of a rare species with few specimens—the engine selects candidate environmental condition sets by Bayesian optimization: it maintains a surrogate model (for example a Gaussian-process regression model) mapping environmental condition sets to a predicted performance metric, and selects the next candidate condition set by optimizing an acquisition function (for example expected improvement or upper confidence bound) over the safe exploration bounds so as to balance exploration and exploitation and to converge on favorable conditions in few trials. In a preferred embodiment the surrogate model is warm-started with a prior derived from the native-habitat time-series 712—for example the prior mean favors condition sets near the observed habitat conditions—so that the search begins from the evolutionarily indicated region of the parameter space, further improving sample efficiency.

At 506, when the accumulated data for the species exceeds the threshold, the engine transitions to a data-driven control policy—for example a supervised machine-learning model trained to predict performance or to recommend setpoints, and/or a reinforcement-learning policy trained to select actions (setpoint changes) so as to maximize a reward derived from one or more phenotype metrics—to further optimize and maintain conditions. The transition thus changes the algorithmic approach as a function of accumulated data, using sample-efficient Bayesian optimization while data is scarce and a higher-capacity data-driven policy once sufficient data exists. In some embodiments the reinforcement-learning policy is represented by a neural network and trained by a policy-gradient or Q-learning method on a state comprising sensor readings and one or more phenotype metrics, an action comprising an adjustment to one or more setpoints, and a reward comprising a change in a phenotype metric between successive images; and the predetermined threshold at which the engine transitions from Bayesian optimization is a number of completed trials or specimens for the species, for example at least ten or at least thirty. At 508 the selected conditions (subject to the safe bounds) are converted to control profiles and applied.

### 7. Computer-Vision Phenotyping (FIG. 6)

FIG. 6 is a data-flow diagram of a phenotyping pipeline, which may execute on the server 120 or, in part, on the controller 228 (edge inference). At 602, one or more images of a specimen are captured by the camera 216. At 604, the specimen is segmented from the background (for example by a trained segmentation model or by color/depth thresholding). At 606, one or more phenotype metrics are derived from the segmented image, which may include any one or more of: a height, a width or diameter, a projected area, a volume estimate, a count of structures (for example ribs, areoles, leaves, or offsets), a color or color-distribution metric, a health or stress index (for example derived from a vegetation index computed from multispectral or infrared channels), a symmetry or morphology metric, and a growth-rate metric computed by comparing metrics across images captured at different times. At 608, the phenotype metrics are associated with the specimen, species, and the concurrent environmental conditions and stored in the feature store 306, where they serve as the performance metric or reward used by the optimization/experiment engine 308 and, in the germination embodiment (FIG. 8), to detect germination events per cell.

### 8. Segmented Germination Array (FIG. 8)

FIG. 8 depicts a grow bed 234 segmented into an array 236 of cells 238 arranged in m rows by n columns, each cell 238 receiving substrate and configured to receive a seed or seeds of the species. The grow unit is configured to condition cells 238 independently—for example the irrigation subsystem 210 includes independently addressable outputs delivering an individually controlled quantity of water and/or nutrient to respective cells 238, and in some embodiments individual cells or groups of cells are independently conditioned as to temperature, light, or humidity (for example by localized thermal elements, by addressable light elements, or by physical partitions). The camera 216 images the array 236, and the phenotyping pipeline (FIG. 6) detects, per cell, whether and when a seed has germinated, from which the server computes a germination-yield metric (for example the ratio of germinated seeds to planted seeds, per condition). Different cells 238 may be assigned different candidate condition sets (within the safe exploration bounds of FIG. 4), whereby the array 236 constitutes a within-unit designed experiment: per-cell germination outcomes are fed to the optimization/experiment engine 308 and combined with cross-unit data to optimize germination conditions for the species. The engine 308 thereby maintains, for the species, a model of a germination response—for example a germination probability or a germination-yield metric as a function of an assigned condition set. In some embodiments the engine 308 determines, using the germination-response model, a refined irrigation condition and transmits the refined irrigation condition to the grow unit, which operates the independently addressable outputs of the irrigation subsystem 210 to apply the refined irrigation condition to one or more of the cells 238, thereby closing the loop for germination. Because the per-cell conditions are actuated in a closed loop and scored automatically by computer vision and fed to the cross-user/habitat-seeded model, the array 236 differs from passive, manually scored gradient germination apparatus.

### 9. Data Protection and Subscription Context

As noted with reference to FIG. 3, in a preferred embodiment the aggregated cross-user dataset and the trained per-species models are retained at the server 120 and are not transmitted to the grow units 110 or exposed to users; instead the server transmits machine-applied control profiles. This architecture confers the benefit of the aggregated data (improved growing conditions) upon a user's grow unit while protecting the underlying data and models against exfiltration by a user or competitor. Access to profiles or to particular capabilities may be conditioned on a subscription or other entitlement by the module 318.

### 10. Rare-Species and Few-Specimen Embodiment

In an embodiment adapted to a species of which only a limited number of specimens or seeds are available (for example fewer than a threshold number), the limited specimens are distributed across a plurality of the grow units 110, the server conducts the coordinated experiment of FIG. 4 across those units using sample-efficient Bayesian optimization (FIG. 5) with a native-habitat-derived prior and habitat-derived safe bounds, and thereby determines favorable growing conditions for the species using fewer specimens than would be required by per-unit trial and error. This embodiment addresses the situation in which conventional device-derived learning converges too slowly because specimens are scarce.

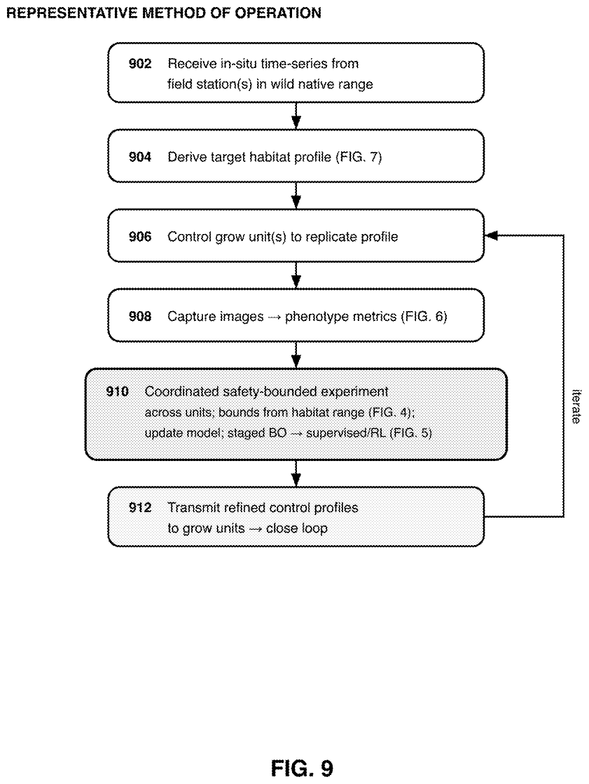

### 11. Representative Method of Operation (FIG. 9)

FIG. 9 summarizes a representative method. At 902, in-situ environmental time-series are received from one or more field stations 130 in a species' wild native range. At 904, a target habitat profile is derived. At 906, one or more grow units 110 are controlled to replicate the habitat profile. At 908, images of the specimens are captured and phenotype metrics derived (FIG. 6). At 910, where a plurality of units grow the species, a coordinated safety-bounded experiment is conducted with habitat-derived bounds (FIG. 4), and the growth-response model is updated (optionally by staged Bayesian/supervised/RL control, FIG. 5). At 912, refined control profiles are transmitted to the grow units to close the loop. The method may iterate.

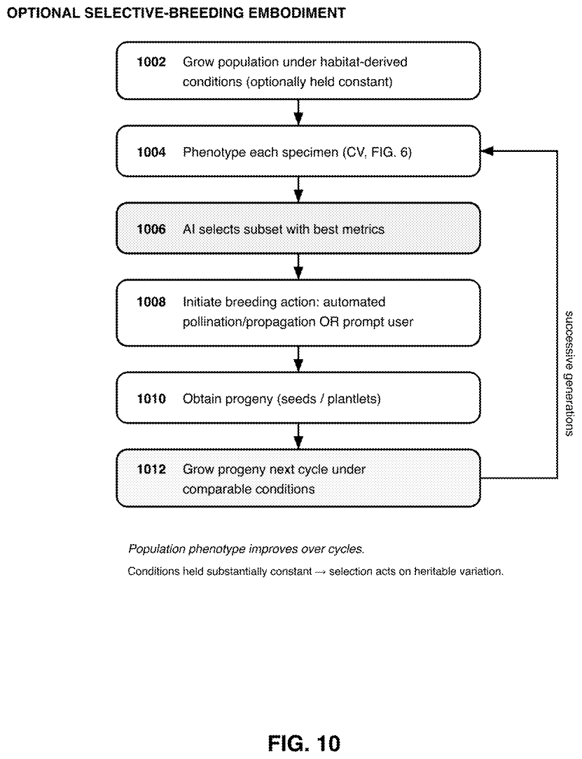

### 12. Optional Selective-Breeding Embodiment (FIG. 10)

FIG. 10 depicts an optional embodiment in which the system additionally guides selective breeding to improve a plant line of the plant species. At 1002, a population of specimens of the species is grown across one or more grow units 110 under environmental conditions derived as above (for example habitat-derived conditions, optionally held substantially constant across the population to expose heritable differences). At 1004, each specimen is phenotyped by computer vision (FIG. 6). At 1006, the server selects, by an artificial-intelligence decision module, a subset of specimens having favorable phenotype metrics. At 1008, a breeding action is initiated among the selected subset—for example by prompting a user, or by operating an automated pollination or propagation mechanism, to cross or clone the selected specimens. At 1010, progeny (seeds or plantlets) are obtained and, at 1012, grown in the grow units for a subsequent cycle under comparable conditions, whereby the population's performance improves over successive cycles. In some embodiments the environmental conditions are held substantially constant across generations so that selection acts on heritable variation. The artificial-intelligence decision module comprises one or more processors executing a selection model that applies a selection criterion to the phenotype metrics—for example a trained machine-learning classifier or a ranking function that ranks the specimens by one or more phenotype metrics and selects a top-ranked subset. In some embodiments, operating the automated pollination or propagation mechanism comprises actuating a robotic pollinator, for example a robotic actuator bearing a brush or an air or electrostatic pollen-transfer end-effector that moves, under control of the controller and guided by image-derived coordinates of the selected specimens, to transfer pollen between flowers of the selected subset to cross them, or actuating a propagation mechanism to excise and root tissue of a specimen of the selected subset to clone it. This embodiment is optional and independent of the habitat-replication and experimentation aspects described above.

### 13. Alternatives and Generalizations

The plant “species” referred to herein may be read as any taxonomic or cultivation grouping (species, subspecies, variety, cultivar, or population). The grow unit 110 need not be enclosed and need not be tabletop; the field station 130 may use terrestrial rather than satellite connectivity where available; the “native range” measurements may be supplemented by or, in some embodiments, replaced with archival environmental records for the native range. The server 120 functions may be distributed among cloud resources, the grow units 110 (for example federated learning in which model updates rather than raw data are aggregated), and the client 150. The optimization objective may combine multiple phenotype metrics and may include resource-use or time-to-maturity terms. Actuators, sensors, and phenotype metrics may be added, omitted, or substituted. Any method herein may be embodied as instructions stored on a non-transitory computer-readable medium that, when executed by one or more processors, cause the system to perform the method.

As used herein: the “wild native range” of a plant species means a geographic area in which the species occurs naturally, without human cultivation, as distinguished from a cultivated field or a controlled environment. An exploration bound, target value, setpoint, or profile is described as “safe” when it confines an environmental parameter to a range the species encounters in its wild native range and/or to values above one or more predetermined absolute floors, for example a nonzero minimum illumination and an above-freezing minimum temperature. An environmental condition, setpoint, or profile is “held substantially constant” across specimens or cycles when it does not vary by more than a predetermined tolerance selected to preserve the described effect, for example by no more than ±10% of the setpoint value or within a tolerance band of the target habitat profile, such that differences in measured phenotype are attributable predominantly to heritable variation rather than to environmental variation. A “predetermined threshold” is a value set before its use, for example a number of trials or specimens, such as ten or thirty, or a number of available specimens below which a species is treated as rare.

The foregoing embodiments are illustrative; the scope of protection is defined by the claims.

What is claimed is:

1. A system for cultivating a plant species, comprising: a plurality of grow units, each grow unit comprising a growth chamber, one or more environmental sensors including a camera, one or more environmental actuators operable to alter an environmental condition within the growth chamber, and a communication interface; and a server configured to: receive, from the plurality of grow units, growth data including one or more phenotype metrics derived from images, captured by the cameras of the plurality of grow units, of specimens of the plant species grown in the grow units; update, based on the received growth data, a model of a growth response of the plant species; and transmit, to at least one of the grow units, an environmental control profile determined using the model, the environmental control profile causing the one or more environmental actuators of the at least one grow unit to alter the environmental condition within its growth chamber.

2. The system of claim 1, wherein the one or more phenotype metrics comprise at least one of a height, a width, a projected area, and a color index derived by segmenting a specimen from the images.

3. The system of claim 1, wherein the server partitions the growth data by plant species and maintains a respective model of a growth response for each of a plurality of plant species.

4. The system of claim 1, wherein the model comprises a Gaussian-process regression surrogate model, and the server selects a candidate environmental condition set by optimizing an acquisition function over the surrogate model.

5. The system of claim 1, wherein the server assigns different environmental condition sets to different grow units of the plurality that are growing specimens of the same plant species, and updates the model using the assigned environmental condition sets and the phenotype metrics resulting therefrom.

6. The system of claim 5, wherein the assigned environmental condition sets are constrained to lie within safe bounds comprising a nonzero minimum illumination and an above-freezing minimum temperature.

7. The system of claim 1, wherein the server does not transmit the model or the received growth data to the grow units, and the environmental control profile is transmitted in encrypted form.

8. A system for cultivating a plant species, comprising: a field station configured for deployment in a wild native range of the plant species, the field station comprising a housing configured to withstand outdoor environmental conditions of the wild native range for unattended operation over a period spanning at least one annual cycle, a solar power source, one or more sensors operable to measure one or more environmental parameters at the wild native range, and a wireless transceiver operable to transmit an in-situ environmental time-series of the measured environmental parameters spanning the at least one annual cycle; a server configured to receive the in-situ environmental time-series and to derive therefrom a target habitat profile specifying target values of the one or more environmental parameters as a function of time of day and time of year; and a grow unit located outside the wild native range and containing a specimen of the plant species, the grow unit comprising a growth chamber containing the specimen, one or more environmental sensors, one or more environmental actuators, and a controller; wherein the controller operates the one or more environmental actuators, in accordance with the target habitat profile and responsive to the one or more environmental sensors, to physically adjust an environmental condition within the growth chamber so as to cause a measured value of the environmental condition to track the target values as a function of time of day and time of year, thereby replicating environmental conditions of the wild native range of the plant species within the growth chamber and cultivating the specimen.

9. The system of claim 8, wherein the wireless transceiver comprises a satellite transceiver, and the field station is configured for unattended outdoor operation powered by the solar power source over a period spanning a plurality of annual cycles.

10. The system of claim 8, wherein the target habitat profile specifies a diel cycle and a seasonal cycle of at least a light setting and a temperature setting, and the controller reproduces the diel cycle and the seasonal cycle within the growth chamber.

11. The system of claim 8, wherein the one or more environmental parameters comprise at least one of temperature, illumination intensity, illumination spectrum, humidity, substrate moisture, and substrate composition.

12. The system of claim 8, wherein deriving the target habitat profile comprises mapping a measured illumination intensity and spectrum at the wild native range to an intensity and a spectral channel setting of a grow-light assembly of the grow unit.

13. The system of claim 8, wherein the grow unit is a tabletop grow unit and the growth chamber is enclosed.

14. The system of claim 8, wherein the server is further configured to conduct a coordinated experiment across a plurality of grow units growing specimens of the plant species by assigning different candidate environmental condition sets, each within a safe exploration bound derived from a range of an environmental parameter observed in the in-situ environmental time-series, to different grow units of the plurality, and by updating a model of a growth response of the plant species based on phenotype metrics derived by computer vision analysis of the specimens.

15. The system of claim 8, wherein deriving the target habitat profile comprises aggregating the in-situ environmental time-series over a plurality of annual cycles, and the field station is configured to measure the one or more environmental parameters at a granularity of at least once per hour.

16. The system of claim 8, wherein deriving the target habitat profile comprises time-shifting the target values, as a function of time of day and time of year, from a local time of the wild native range to a local time of the grow unit.

17. The system of claim 8, wherein the one or more environmental parameters comprise a substrate composition comprising at least one of an electrical conductivity and a pH, the grow unit comprises a substrate-composition sensor and an irrigation subsystem operable to deliver dissolved nutrients, and the controller operates the irrigation subsystem to move a sensed substrate composition toward a target value of the target habitat profile.

18. The system of claim 8, wherein the target habitat profile further specifies, for each of the one or more environmental parameters, a tolerance about the target value for that environmental parameter, and the controller maintains the measured value of the environmental condition within the tolerance.

19. A system for cultivating a plant species, comprising: a grow unit comprising a growth chamber configured to contain a specimen of the plant species, one or more environmental sensors, one or more environmental actuators operable to alter an environmental condition within the growth chamber, and a controller; and one or more processors configured to obtain an in-situ environmental time-series of one or more environmental parameters measured in a wild native range of the plant species over a period spanning at least one annual cycle, and to derive from the in-situ environmental time-series a target habitat profile specifying target values of the one or more environmental parameters as a function of time of day and time of year; wherein the grow unit is located outside the wild native range, and the controller operates the one or more environmental actuators, in accordance with the target habitat profile and responsive to the one or more environmental sensors, to physically adjust the environmental condition within the growth chamber so as to cause a measured value of the environmental condition to track the target values as a function of time of day and time of year, including, responsive to the one or more environmental sensors indicating a deviation of the environmental condition from the target values, adjusting the one or more environmental actuators to reduce the deviation, thereby replicating environmental conditions of the wild native range of the plant species within the growth chamber.

20. A system for cultivating a plant species, comprising: a plurality of grow units, each grow unit comprising a growth chamber, a camera, one or more environmental actuators, and a communication interface, each grow unit growing a specimen of the plant species; at least one field station in a wild native range of the plant species, operable to transmit an in-situ environmental time-series of one or more environmental parameters measured at the wild native range; and a server configured to: determine, for each of the one or more environmental parameters, a safe exploration bound derived from a range of that environmental parameter observed in the in-situ environmental time-series; assign different candidate environmental condition sets to different grow units of the plurality, each assigned candidate environmental condition set lying, for each of the one or more environmental parameters, within the safe exploration bound determined for that environmental parameter; receive, for each of the grow units, a phenotype metric of the specimen thereof derived by computer vision analysis of images captured by the camera thereof; update, using the assigned candidate environmental condition sets and the received phenotype metrics, a model of a growth response of the plant species; and
transmit, to at least one of the grow units, a refined environmental control profile determined using the model, the refined environmental control profile causing the one or more environmental actuators of the at least one grow unit to physically alter an environmental condition within its growth chamber toward a setpoint of the refined environmental control profile.

21. The system of claim 20, wherein the server selects the candidate environmental condition sets by Bayesian optimization using a surrogate model warm-started with a prior derived from the in-situ environmental time-series.

22. The system of claim 21, wherein the Bayesian optimization selects each candidate environmental condition set by optimizing an acquisition function over the safe exploration bound determined for each of the one or more environmental parameters, the acquisition function comprising an expected-improvement acquisition function or an upper-confidence-bound acquisition function.

23. The system of claim 21, wherein a prior mean of the surrogate model favors environmental condition sets near environmental conditions observed in the in-situ environmental time-series.

24. The system of claim 20, wherein the server assigns the candidate environmental condition sets according to a multi-armed-bandit policy.

25. The system of claim 21, wherein the server, responsive to a quantity of accumulated data for the plant species exceeding a predetermined threshold, transitions from selecting the candidate environmental condition sets by Bayesian optimization to controlling the grow units by a supervised machine-learning model or a reinforcement-learning policy.

26. The system of claim 20, wherein the safe exploration bound for each environmental parameter is further constrained by a nonzero minimum illumination and an above-freezing minimum temperature.

27. The system of claim 20, wherein a number of available specimens of the plant species is fewer than a predetermined threshold, and the available specimens are distributed across the plurality of grow units.

28. The system of claim 20, wherein the server does not transmit the model or the phenotype metrics received from the grow units to the grow units, and transmits the refined environmental control profile in encrypted form.

29. The system of claim 20, wherein the phenotype metrics are derived by computer vision analysis performed by the grow units, and the grow units transmit the phenotype metrics to the server without transmitting to the server the images from which the phenotype metrics are derived.

30. The system of claim 20, wherein the phenotype metric comprises a growth-rate metric computed by comparing metrics derived from images of the specimen captured at different times.

31. A method of cultivating a plant species, comprising: receiving, from at least one field station deployed in a wild native range of the plant species, an in-situ environmental time-series of one or more environmental parameters measured at the wild native range over a period spanning at least one annual cycle; deriving, from the in-situ environmental time-series, a target habitat profile specifying target values of the one or more environmental parameters as a function of time of day and time of year; growing a living specimen of the plant species in a growth chamber of a grow unit located outside the wild native range; and controlling one or more environmental actuators of the grow unit, in accordance with the target habitat profile and responsive to one or more environmental sensors of the grow unit, to physically adjust at least one of a light output of a grow-light assembly, a temperature, a humidity, and an irrigation of the growth chamber so as to cause an environmental condition within the growth chamber to track the target values as a function of time of day and time of year, including, responsive to the one or more environmental sensors indicating a deviation of the environmental condition from the target values, adjusting the one or more environmental actuators to reduce the deviation, thereby replicating environmental conditions of the wild native range within the growth chamber and cultivating the living specimen.

32. The method of claim 31, further comprising conducting a coordinated experiment across a plurality of grow units growing specimens of the plant species, the conducting comprising assigning different candidate environmental condition sets, each within a safe exploration bound derived from a range observed in the in-situ environmental time-series, to different grow units of the plurality, and updating a growth-response model based on phenotype metrics derived by computer vision analysis of the specimens.

33. The method of claim 32, wherein assigning the candidate environmental condition sets comprises selecting the candidate environmental condition sets by Bayesian optimization using a surrogate model warm-started with a prior derived from the in-situ environmental time-series.

34. The method of claim 33, further comprising, responsive to a quantity of accumulated data for the plant species exceeding a predetermined threshold, transitioning from selecting the candidate environmental condition sets by Bayesian optimization to controlling the grow units by a supervised machine-learning model or a reinforcement-learning policy.

35. The method of claim 31, wherein the controlling reproduces a diel cycle and a seasonal cycle of the wild native range within the growth chamber.

36. The method of claim 31, wherein deriving the target values comprises aggregating the in-situ environmental time-series over a plurality of annual cycles.

37. A grow unit for germinating seeds of a plant species, comprising: a grow bed segmented into an array of cells arranged in a plurality of rows and a plurality of columns, each cell configured to receive substrate and at least one seed; one or more environmental actuators including an irrigation subsystem having independently addressable outputs operable to deliver an individually controlled quantity of water to respective cells of the array; a camera arranged to image the array of cells; and a controller comprising a processor and a memory storing instructions that, when executed by the processor, configure the controller to: cause different candidate irrigation conditions to be applied to different cells of the array via the independently addressable outputs, each candidate irrigation condition lying within a safe bound derived from a range of an environmental parameter in an in-situ environmental time-series measured in a wild native range of the plant species; detect, per cell and by computer vision analysis of images captured by the camera, a germination of the at least one seed of that cell; compute a germination-yield metric from the germination detected in each of the cells; transmit the germination-yield metric and the applied candidate irrigation conditions to a server configured to update a model of a germination response of the plant species; and responsive to a refined irrigation condition received from the server and determined using the model, operate the independently addressable outputs to apply the refined irrigation condition to one or more cells of the array.

38. The grow unit of claim 37, wherein the safe bound for an environmental parameter comprises a minimum and a maximum of that environmental parameter observed in the in-situ environmental time-series.

39. The grow unit of claim 37, wherein the different candidate irrigation conditions comprise different quantities of water delivered to respective cells by the independently addressable outputs.

40. The grow unit of claim 37, wherein the candidate irrigation conditions applied to the cells are selected by the server by Bayesian optimization, each cell of the array constituting a trial.

41. The grow unit of claim 37, wherein the one or more environmental actuators are operable to condition individual cells or groups of cells of the array independently as to at least one of temperature and light, and the controller applies different candidate temperature or light conditions to different cells of the array, each within a safe bound derived from a range of a corresponding environmental parameter in the in-situ environmental time-series.

42. A method of improving a plant line in an automated cultivation system, comprising: growing a population of specimens of a plant species across one or more grow units, each grow unit controlling an environmental condition within a respective growth chamber in accordance with a target profile derived from an in-situ environmental time-series measured in a wild native range of the plant species; deriving, by computer vision analysis of images of each specimen, a phenotype metric of the specimen; selecting, by one or more processors and based on the phenotype metrics of the specimens, a subset of the specimens whose phenotype metrics satisfy a selection criterion; initiating a breeding action among the selected subset by operating an automated pollination or propagation mechanism to physically cross or clone the selected subset, thereby obtaining progeny; growing the progeny in the one or more grow units for a subsequent cycle in accordance with the target profile; and repeating the deriving, selecting, initiating, and growing for one or more further cycles, to improve a phenotype of the population over successive cycles.

43. The method of claim 42, wherein the target profile is held substantially constant across the successive cycles.

44. The method of claim 42, wherein the environmental condition is held substantially constant across the population so that selection acts on heritable variation among the specimens.

45. The method of claim 42, wherein operating the automated pollination or propagation mechanism comprises actuating a robotic pollinator to transfer pollen between specimens of the selected subset.

46. The method of claim 42, wherein the selecting comprises ranking the specimens by one or more of the phenotype metrics using a trained machine-learning model and selecting a top-ranked subset of the specimens as the selected subset.

47. A non-transitory computer-readable medium storing instructions that, when executed by one or more processors, cause a system to: receive, from at least one field station in a wild native range of a plant species, an in-situ environmental time-series of one or more environmental parameters measured at the wild native range; derive, from the in-situ environmental time-series, a target habitat profile specifying target values of the one or more environmental parameters as a function of time of day and time of year; determine, for each of the one or more environmental parameters, a safe exploration bound derived from a range of that environmental parameter in the in-situ environmental time-series; assign different candidate environmental condition sets to different grow units of a plurality of grow units growing specimens of the plant species, each assigned candidate environmental condition set lying, for each of the one or more environmental parameters, within the safe exploration bound determined for that environmental parameter; update, based on phenotype metrics derived by computer vision analysis of the specimens, a model of a growth response of the plant species; and transmit environmental control profiles determined using the model to the grow units, each environmental control profile specifying time-varying setpoints that define a diel and seasonal schedule derived from the target habitat profile and that cause a controller of a respective grow unit to operate one or more environmental actuators, in a closed loop responsive to one or more environmental sensors of the respective grow unit, to physically alter environmental conditions within a respective growth chamber toward the setpoints, wherein the model and the phenotype metrics are not transmitted to the grow units.
